(19) United States
(12) Patent Application Publication
(10) Pub. No.: US 2013/0208892 A1
(43) Pub. Date: Aug. 15, 2013

(54) COMPUTER SYSTEM AND COMPUTER SYSTEM CONTROL METHOD

(71) Applicants: Mioko Moriguchi, Yokohama (JP); Hirotaka Nakagawa, Sagamihara (JP)

(72) Inventors: Mioko Moriguchi, Yokohama (JP); Hirotaka Nakagawa, Sagamihara (JP)

(73) Assignee: HITACHI LTD., Tokyo (JP)

(21) Appl. No.: 13/500,128

(22) PCT Filed: Feb. 15, 2012
(86) PCT No.: PCT/JP2012/001003

§ 371 Date: Apr. 4, 2012

(51) Int. Cl. H04L 9/00

(52) U.S. Cl. 380/277

(57) ABSTRACT

When removing an HDD, in which a failure has occurred, after the execution of hot swap in a storage apparatus having a stored data encryption function, an encryption key assigned to that HDD is shredded and thereby data in the HDD is automatically crypto-shredded; and after a new HDD is installed, data in a spare disk regarding which copy back to the new HDD is completed is automatically crypto-shredded and key generation for the spare disk is requested to a security administrator in preparation for the next hot swap. Then, with the storage apparatus which imports and uses an encryption key generated by an external key management server for encryption/decoding of stored data, the encryption key for the spare disk is imported from the external key management server in advance and the encryption key is prevented from the use other than the intended use in preparation for a case where the encryption key may not be imported due to a communication failure with the external key management server at the time of the hot swap, thereby causing a shortage of encryption keys.

### TECHNICAL FIELD

The present invention relates to a computer system equipped with a storage apparatus and a method for controlling the computer system. Particularly, the invention relates to a computer system equipped with an encryption key management function at the time of hot swap of a storage medium in which data is encrypted and stored.

### BACKGROUND ART

In order to prevent data leakage by, for example, a theft of a storage medium connected to a storage apparatus, the storage apparatus is configured so that it encrypts data received with a write request from a host computer and stores the encrypted data in storage media; and when receiving a read request to read the data from the host computer, the storage apparatus decodes and reads the encrypted data from the storage media and sends it to the host computer.

This type of storage apparatus executes processing for encrypting and decoding the stored data by using an encryption key that is set on a storage medium basis. If a failure occurs in a storage medium such as an HDD and the HDD in which the failure occurred is to be hot-swapped, there is a suggested storage apparatus designed to use a collection copy function to assign an encryption key to a spare disk by exchanging the encryption key from the HDD, in which the failure occurred, to the spare disk (WO2010/137177).

Furthermore, there is also a suggested method for always encrypting all storage media contained in a storage apparatus wherein coexistence of the encrypted storage media and storage media which are not encrypted is not allowed (EMC Symmetrix Data at Rest Encryption (EMC Corporation, white paper, November 2010)).

### CITATION LIST

### Patent Literature

PTL 1: WO2010/137177

### Non Patent Literature

NPL 1: EMC Symmetrix Data at Rest Encryption (EMC Corporation, white paper, November 2010)

### SUMMARY OF INVENTION

### Technical Problem

With the storage apparatus, key information management is important in order to prevent data loss due to the incapability to decode the encrypted data because of loss of the encryption key, or prevent information leakage by loss of the encryption key or leakage of the encryption key. PTL 1 discloses a method for protecting the encrypted data at the time of an HDD failure; however, it does not give any consideration to the management of the encryption key. Also, regarding NPL 1, all the integrated storage media are encrypted, so that double encryption is performed in an IT system which adapts a host-computer-based encryption method, thereby degrading I/O performance. Furthermore, NPL 1 does not give any consideration to an encryption key management method.

Under the circumstance where a storage medium has to be hot-swapped, data leakage or data loss cannot be prevented unless the encryption key management is sufficient. For example, if an encryption key for a storage medium, in which a failure occurred, leaks, there is a possibility that data might leak from the failed storage medium which is removed from the storage apparatus. Also, if a spare storage medium cannot be encrypted at the time of hot swap due to a shortage of encryption keys, confidentiality of data in a spare drive may degrade or the hot swap itself may not be performed. Under this circumstance, there is a possibility that a multiplicity of failures may occur in storage media, which may cause data loss.

Therefore, it is an object of this invention to provide a computer system and computer system control method capable of reliably preventing data leakage and data loss even under the circumstance where a storage medium has to be removed from the system, for example, where a failure has occurred in an encrypted storage medium.

### Solution to Problem

In order to achieve the above-described object, a first invention is a computer system for dividing data from a host computer into a plurality of divided data and generating parity based on the plurality of divided data, assigning key information to each of a plurality of storage media, and encrypting, distributing, and storing the parity and the plurality of divided data in the plurality of storage media; the computer system includes: a first circuit constituting an interface with the host computer; a second circuit constituting an interface with the plurality of storage media; and a controller for restoring the parity or the divided data, which are stored in a specific storage medium belonging to the plurality of storage media, to a spare storage medium; wherein the controller: determines the specific storage medium from among the plurality of storage media; stores the parity or the divided data, which are stored in the specific storage medium, in the spare storage medium based on the plurality of storage media other than the specific storage medium; and controls timing to cancel the key information assigned to the specific storage medium based on timing to finish storing the parity or the divided data in the spare storage medium and cancels the key information in accordance with the controlled timing.

The present invention is equipped with a function controlling the timing to cancel key information from a storage medium removed from the system, so that the timing to cancel the key from the storage medium can be optimized according to the invention in order to, for example, avoid too early timing to cancel the key information, which may cause data loss due to, for example, multiple failures of the storage media, or avoid too late timing to cancel the key information, which may cause data leakage from the storage medium removed from the system.

Furthermore, a second invention is a computer system for dividing data from a host computer into a plurality of divided data and generating parity based on the plurality of divided data, assigning key information to each of a plurality of storage media, and encrypting, distributing, and storing the parity and the plurality of divided data in the plurality of storage media; the computer system includes: a first circuit constituting an interface with the host computer; a second circuit constituting an interface with the plurality of storage media; and a controller for restoring the parity or the divided data, which are stored in a specific storage medium belonging to the plurality of storage media, to a spare storage medium; wherein the controller: determines the specific storage medium from among the plurality of storage media; assigns key information to the spare storage medium; encrypts and stores the parity or the divided data, which are stored in the specific storage medium, in the spare storage medium based on the plurality of storage media other than the specific storage medium; cancels the key information assigned to the specific storage medium when removing the specific storage medium from a storage area of the plurality of storage media; migrates the parity and/or the divided data, which are restored in the spare storage medium, to another storage medium to which the key information is assigned; and cancels the key information assigned to the spare storage medium if the migration of the parity or the divided data is completed.

Furthermore, a third invention is a method for controlling a computer system for dividing data from a host computer into a plurality of divided data and generating parity based on the plurality of divided data, assigning key information to each of a plurality of storage media and encrypting, distributing, and storing the parity and the plurality of divided data in the plurality of storage media, wherein when restoring the parity or the divided data, which are stored in a specific storage medium belonging to the plurality of storage media, to a spare storage medium, the computer system: determines the specific storage medium from among the plurality of storage media; stores the parity or the divided data, which are stored in the specific storage medium, in the spare storage medium based on the plurality of storage media other than the specific storage medium; and controls timing to cancel the key information assigned to the specific storage medium based on timing to finish storing the parity or the divided data in the spare storage medium and cancels the key information in accordance with the controlled timing.

### Advantageous Effects of Invention

According to the present invention, it is possible to provide a computer system and computer system control method capable of reliably preventing data leakage and data loss even under the circumstance where a storage medium has to be removed from the system, for example, where a failure has occurred in an encrypted storage medium.

### BRIEF DESCRIPTION OF DRAWINGS

FIG. 1 is a block diagram showing the configuration of an embodiment of a computer system belonging to the present invention.

FIG. 2 is a hardware block diagram showing the configuration of an embodiment of a storage apparatus belonging to the computer system.

FIG. 3 is a block diagram of a logical configuration of a local memory for a microprocessor package of the storage apparatus.

FIG. 4 is a block diagram showing a hardware configuration of a management computer for the storage apparatus for executing, for example, management of an encryption function of the storage apparatus.

FIG. 5 is a block diagram showing a logical configuration of a memory for the relevant management computer.

FIG. 6 is a configuration example for a parity group management table to which an HDD management function in FIG. 3 refers.

FIG. 7 is a configuration example for an HDD management table to which the HDD management function in FIG. 3 refers.

FIG. 8 is a configuration example for a hot swap management table to which the HDD management function in FIG. 3 refers.

FIG. 9 is a configuration example for a hot swap management table to which the HDD management function in FIG. 3 refers.

FIG. 10 is a flowchart illustrating processing for removing an HDD from the storage apparatus and shredding an encryption key for that HDD.

FIG. 11 is a flowchart following FIG. 10.

FIG. 12 is a flowchart for controlling the timing to execute collection copying to a spare disk and shredding of the encryption key assigned to the removal target HDD.

FIG. 13 is a flowchart for explaining processing for assigning the encryption key to an HDD newly added to the storage apparatus.

FIG. 14 is a flowchart for explaining processing for retaining the encryption key assigned to an HDD for a certain period of time and then shredding the relevant key if that HDD is not reinstalled within the certain period of time.

FIG. 15 is a flowchart for explaining processing for importing the encryption key, which should be assigned to a spare disk, from an external key management server in advance.

FIG. 16 is a flowchart for explaining processing for assigning the encryption key to HDDs constituting a parity group for which an encryption-setting-on request is made.

FIG. 17 is a flowchart for explaining processing for requesting the external key management server to import the encryption key when the number of encryption keys in an unassigned state is less than the number of spare disks in an unused state.

FIG. 18 is an example of an encryption key generation policy setting GUI.

FIG. 19 is an example of an encryption key management policy table.

FIG. 20 is a flowchart for explaining processing for generating the encryption key in accordance with an encryption key management policy designated by a user.

FIG. 21 is a flowchart for explaining processing for cancelling the encryption key in accordance with the encryption key management policy designated by the user.

FIG. 22 is the form of an example of a warning reported from a key management function to a management terminal of an administrative user.

### DESCRIPTION OF EMBODIMENTS

### First Embodiment

Next, embodiments of the present invention will be explained. Firstly, a first embodiment will be explained. The first embodiment relates to a computer system capable of encryption of storage media based on a controller for a storage apparatus. The computer system sets encryption to a parity group; and if a failure occurs in an HDD constituting the parity group, the computer system implements hot swap. Then, when the HDD in which the failure occurred is removed from the system and a new HDD is added to the system, the computer system shreds an encryption key assigned to the removed HDD and thereby automatically crypto-shreds data stored in the HDD.

Subsequently, the computer system: restores the data or parity of the specific HDD, in which the failure occurred, by means of collection copying from another HDD constituting the same parity group as that of the HDD in which the failure occurred; copies back the restored data in a spare disk to the other HDD; and then also shreds an encryption key assigned to the spare disk, thereby automatically crypto-shreds the data stored in the spare disk.

Furthermore, the storage apparatus requests a security administrator to generate an encryption key for the spare disk in preparation for the next hot swap.

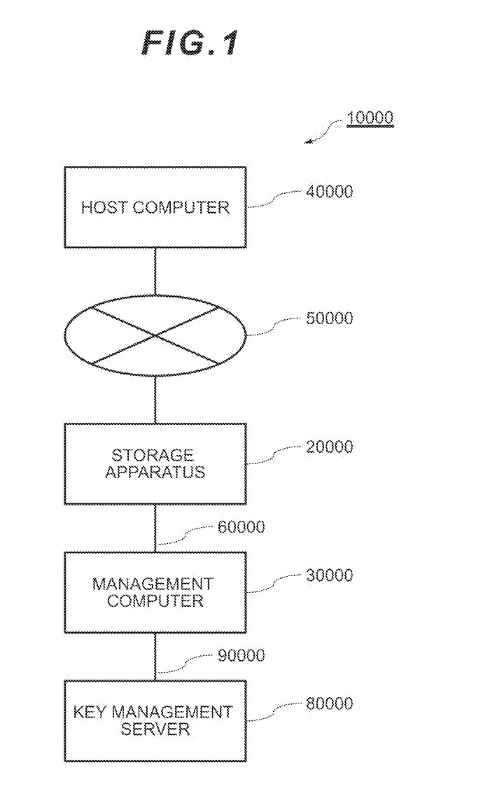

FIG. 1 is a block diagram showing the configuration of the computer system. This computer system 10000 includes a host computer 40000, a storage apparatus 20000, a management computer 30000, and a key management server 80000. The host computer 40000 and the storage apparatus 20000 are connected via a first network 50000 such as a SAN (Storage Area Network). The management computer 30000 and the storage apparatus 20000 are connected via a first management network 60000 and the management computer 30000 and the key management server 80000 are connected via the second management network 90000. The first network 50000 and the first and second management networks 60000, 90000 may be the same network.

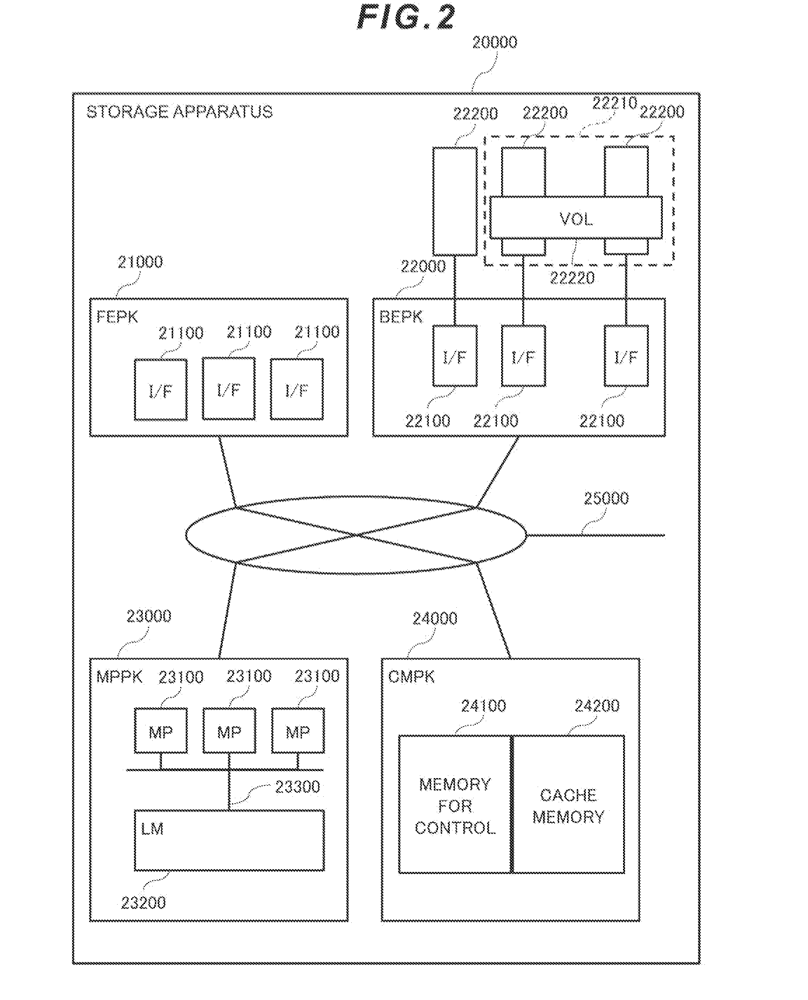

The storage apparatus 20000 includes a host computer I/F unit (FEPK: FrontEnd PacKage) 21000, a media I/F unit (BEPK: BackEnd PacKage) 22000, a control unit (MPPK: Micro Processor PacKage) 23000, and a shared memory unit (CMPK: Cache Memory PacKage) 24000 as shown in FIG. 2; and they are connected to each other via an internal network 25000 and can communicate with each other.

The FEPK 21000 has a plurality of host computer I/Fs 21100, is connected via the first network 50000 to the host computer 40000 and also connected to the internal network 25000, and serves as an intermediary upon reception and delivery of read/write processing target data between the host computer 40000 and volumes.

The BEPK 22000 has a plurality of media I/Fs 22100, is connected via a cable to physical storage devices (for example, HDDs and semiconductor memories such as flash memories) 22200 and also connected to the internal network 25000, and serves as an intermediary upon reception and delivery of read/write processing target data between the internal network side and the physical storage devices 22200.

The CMPK 24000 has a control information memory (MEMORY FOR CONTROL) 24100 and a data cache memory (CACHE MEMORY) 24200; and the information control memory 24100 stores information necessary for processing such as control information and configuration information; and the data cache memory 24200 temporarily stores (caches) data to be written to the physical storage devices 22200 or data read from the physical storage devices 22200. The control information memory 24100 and the data cache memory 24200 may be volatile memories such as DRAM (Dynamic Random Access Memory).

The MPPK 23000 is configured so that a plurality of Micro Processors (MP) 23100 and a Local Memory (LM) 23200 are connected via a bus 23300; and the LM 23200 stores part of the control information stored in the control information memory 24100. The MP 23100 sets a logical storage area 22210 (hereinafter referred to as the parity group) constituted from a group of a plurality of physical storage devices of the same type, cuts out part of the parity group 22210 as a volume 22220, and provides it to the host computer 40000.

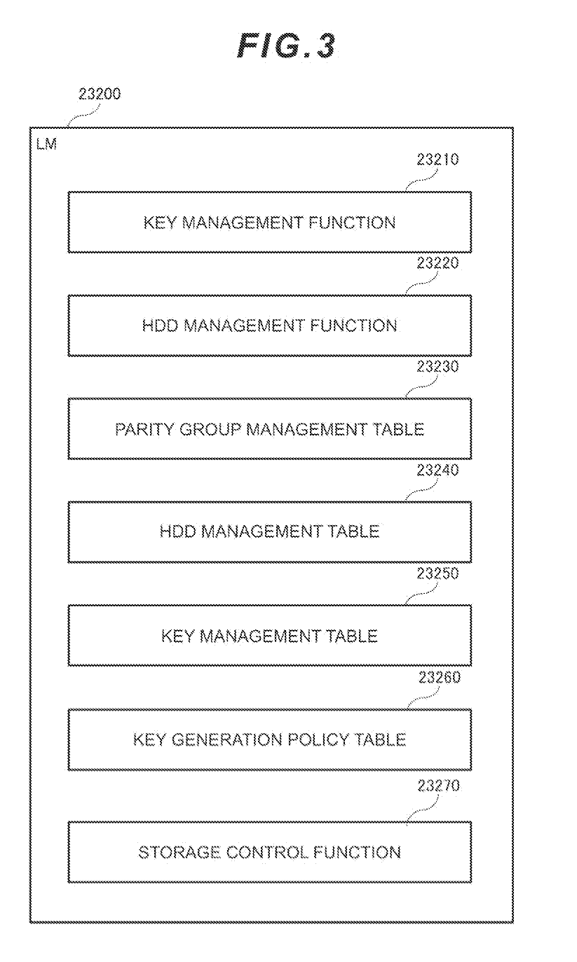

FIG. 3 shows a logical configuration example for the LM 23200 in the MPPK 23000. A key management function 23210 realizes various control processing relating to encryption keys by using a key management table 23250 and a key generation policy table 23260. Specifically speaking, when receiving a request for assignment of an encryption key to an HDD from an HDD management function 23220, the key management function 23210 refers to the key management table 23250 and returns an ID of an encryption key, which is not assigned to any HDD, to the HDD management function. Then, if there is no unassigned key, the key management function 23210 refers to the key generation policy table 23260; and if a key generation policy is to internally generate an encryption key, the key management function 23210 generates an encryption key and stores it in the key management table 23250.

The HDD management function 23220 refers to a parity group management table 23230 and an HDD management table 23240; and if an encryption key is assigned to the HDD at the time of removal of the HDD, the HDD management function 23220 requests the key management function 23210 to shred the encryption key and also request to assign a new encryption key to an HDD to be newly installed in the storage apparatus.

A storage control function 23270 monitors HDD installation slots; and if an HDD is installed in, or removed from, the storage apparatus, the storage control function 23270 reports it to the HDD management function 23220.

Each of the key management function 23210, the HDD management function 23220, and the storage control function 23270 is achieved by programs. Incidentally, these functions may be achieved by dedicated integrated circuits.

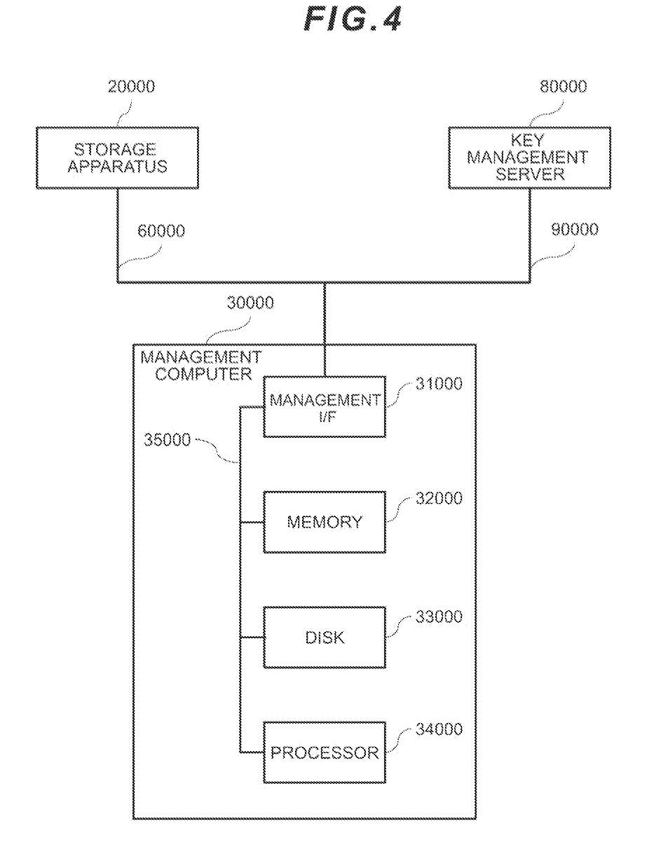

The management computer 30000 is equipped with a management I/F 31000, a memory 32000, a disk 33000, and processor 34000 as shown in FIG. 4 and also equipped with an input device and output device not shown in the drawing; and they are connected via an internal network 35000 and can communicate with each other. The management I/F 31000 is an IF for connecting the management computer 30000 to the first management network 60000 and the second management network 90000. This management I/F 31000 is assigned its unique network address such as a WWN (World Wide Name) or an IP (Internet Protocol) address. The input device is composed of, for example, a keyboard and a mouse and is used for a user to input various operations. Also, the output device is composed of, for example, a display and a speaker and displays a GUI (Graphical User Interface) and various information under control of the processor.

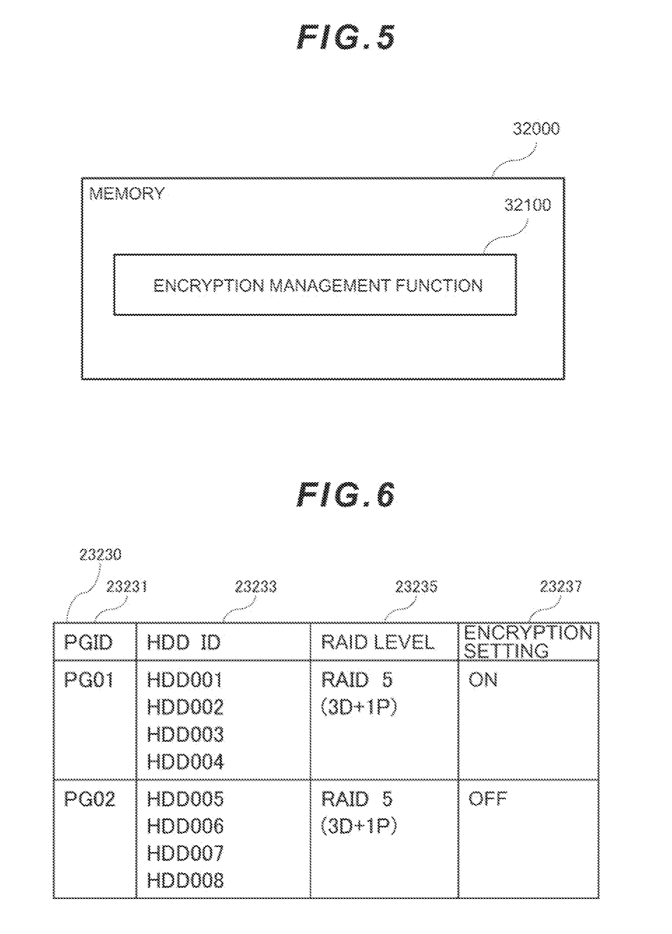

FIG. 5 shows a logical configuration example for the memory 32000 in the management computer 30000. An encryption management function 32100 provides the user with a key generation policy setting GUI, a parity group encryption setting GUI, and a key import request GUI and imports encryption keys from the key management server 80000.

FIG. 6 shows a configuration example for the parity group management table 23230 to which the HDD management function 23220 refers. The parity group management table 23230 is constituted from: a PG ID column 23231 indicating an ID capable of uniquely identifying a parity group in the storage apparatus 20000; an HDD ID column 23233 indicating an ID capable of globally and uniquely identifying HDDs constituting the relevant parity group; a RAID level column 23235 indicating a RAID level of the relevant parity group; and an encryption setting column 23237 indicating an attribute of the parity group, for example, whether an encryption setting of the relevant parity group is on or off.

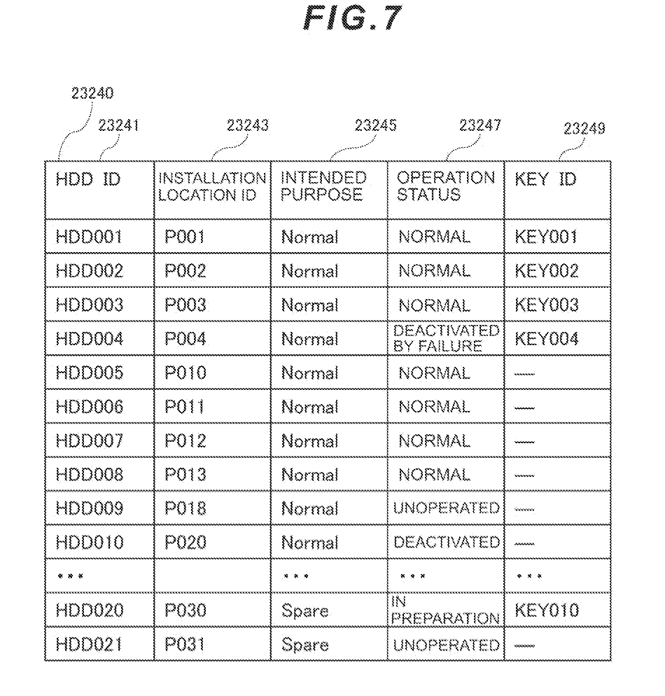

FIG. 7 shows a configuration example for the HDD management table 23240 to which the HDD management function 23220 refers. The HDD management table 23240 is constituted from: an HDD ID column 23241 indicating an ID capable of globally and uniquely identifying an HDD installed in the storage apparatus 20000; an installation location ID column 23245 indicating the installation location of the relevant HDD in a chassis for the storage apparatus; an intended purpose column 23245 showing the intended purpose of the relevant HDD; an operation status column 23247 showing the operation status of the relevant HDD; and a key ID column 23249 indicating an ID capable of uniquely identifying an encryption key assigned to the relevant HDD in the apparatus.

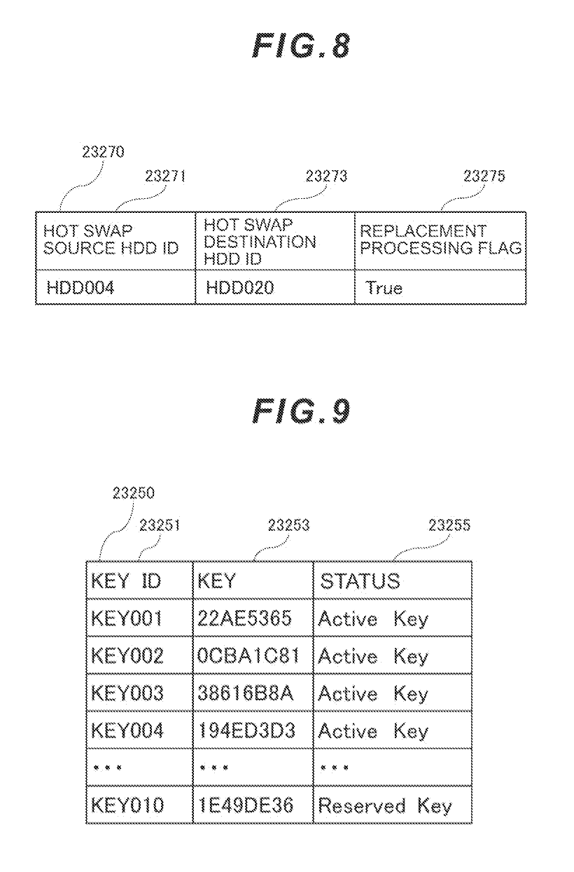

FIG. 8 shows a configuration example for a hot swap management table 23270 to which the HDD management function 23220 refers. The hot swap management table 23270 is constituted from: a hot swap source HDD ID column 23271 used, when a failure occurs in an HDD constituting a parity group and hot swap is to be executed, to store an HDD ID of the HDD which is a hot swap source and in which the failure occurred; a hot swap destination HDD ID column 23273 for storing an HDD ID of a spare disk for performing hot swap of the HDD in which the failure occurred; and a replacement processing flag column 23275 indicating that replacement processing on the spare disk for the HDD in which the failure occurred is being executed.

FIG. 9 shows a configuration example for the key management table 23250 to which the key management function 23210 refers. The key management table 23250 is constituted from: a key ID column 23251 indicating an ID capable of uniquely identifying an encryption key in the storage apparatus; a key column 23253 indicating a main body of the relevant encryption key; and a status column 23255 indicating the status of the relevant encryption key. The status “Active Key” in the status column 23255 means that the encryption key is used for encryption; and the status “Reserved Key” means that the encryption key has not been used yet for encryption and is still retained.

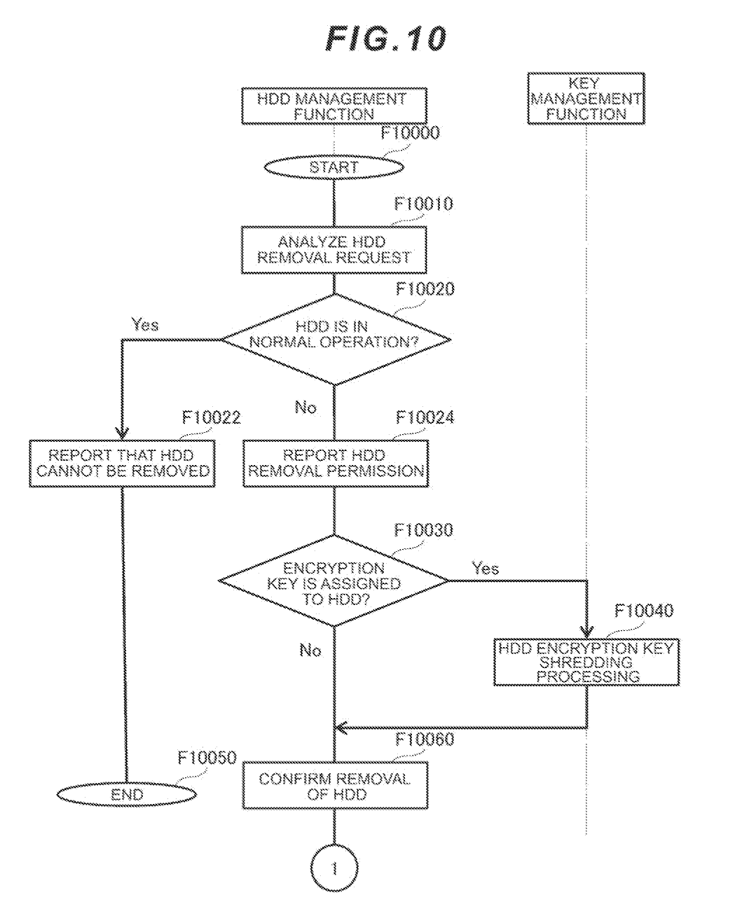

Next, an encryption key management method for the storage apparatus according to the first embodiment will be explained. Firstly, the outline of the encryption key management method is as follows. When an administrator of the storage apparatus intends to remove a specific HDD, in which a failure occurred, and if an encryption key is assigned to the relevant HDD, the storage apparatus shreds the relevant encryption key and executes processing for crypto-shredding data stored in the relevant HDD. Then, when copy-back of data is performed from a spare disk to an HDD newly installed in the storage apparatus and if an encryption key is assigned to the relevant spare disk, the data stored in the relevant spare disk is crypto-shredded by shredding the relevant encryption key after the completion of the copy-back. The encryption key control method will be explained in detail based on flowcharts shown in FIG. 10 to FIG. 13.

Referring to FIG. 10, after receiving an HDD removal request designating the installation location ID of an HDD from the user via a GUI provided by the encryption management function 32100 of the management computer 30000, the HDD management function 23220 starts the flow (F10000).

The HDD management function 23220 analyzes the HDD removal request, refers to the installation location ID column of the HDD management table 23240, and identifies an HDD which matches the installation location ID included in the HDD removal request from the user (F10010). Next, the HDD management function 23220 checks if a failure has occurred in the relevant HDD and the HDD is deactivated or not (F10020: No).

If it is determined in step F10020 that the relevant HDD is in normal operation (F10020: Yes), that is, if the operation status column 23247 of the HDD management table 23240 stores information indicating that the relevant HDD is in normal operation (the letter string “Normal” in FIG. 7), or information indicating that the relevant HDD is a spare disk in which data is being migrated (the letter string “In Preparation” in FIG. 7), the HDD management function 23220 notifies the user via the GUI provided by the encryption management function 32100 that the relevant HDD cannot be removed (F10022); and then terminates the flowchart (F10050).

On the other hand, if the relevant HDD is not in normal operation in step F10020, that is, if the operation status column 23247 of the HDD management table 23240 stores information indicating that the relevant HDD is not in normal operation (the letter string “Deactivated by Failure,” or “Unoperated,” or “Deactivated” in FIG. 7), the HDD management function 23220 notifies the user, via the GUI provided by the encryption management function 32100, of the installation location ID of the relevant HDD as well as a removal permission including a removal confirmation input request after the removal (F10024).

Next, the HDD management function 23220 refers to the HDD management table 23240 and judges whether or not an encryption key is assigned to the relevant HDD (F10030). This judgment can be made depending on whether the ID of an encryption key is set to the ID of the removal target HDD in the HDD management table 23240. If it is determined in step F10030 that the encryption key is assigned to the relevant HDD (F10030: Yes), the HDD management function 23220 requests the key management function 23210 to shred the relevant key and the key management function 23210 executes processing for shredding the relevant encryption key (F10040). The processing for shredding the encryption key for the removal target HDD will be explained later. If no encryption key is assigned to the relevant HDD, the HDD management function 23220 does not execute step F10040 and proceeds to the next step F10060. Incidentally, the encryption key of the relevant HDD may be shredded before the removal permission notice for the failed HDD.

If the user removes the HDD with the installation location ID, for which the removal permission was granted in step F10024, and the HDD management function 23220 obtains removal confirmation notice from the user via the GUI provided by the encryption management function 32100 of the management computer 30000 (F10060), the HDD management function 23220 obtains the key ID of the removal target HDD of the HDD management table 23240 from the key ID column 23249 (in a case where the encryption key is set to the HDD) and stores information indicating that replacement processing on the relevant host swap source HDD is being executed (the letter string “True” in FIG. 8), in the replacement processing flag column 23275 of the relevant host swap source HDD in the hot swap management table 23270 (F10060).

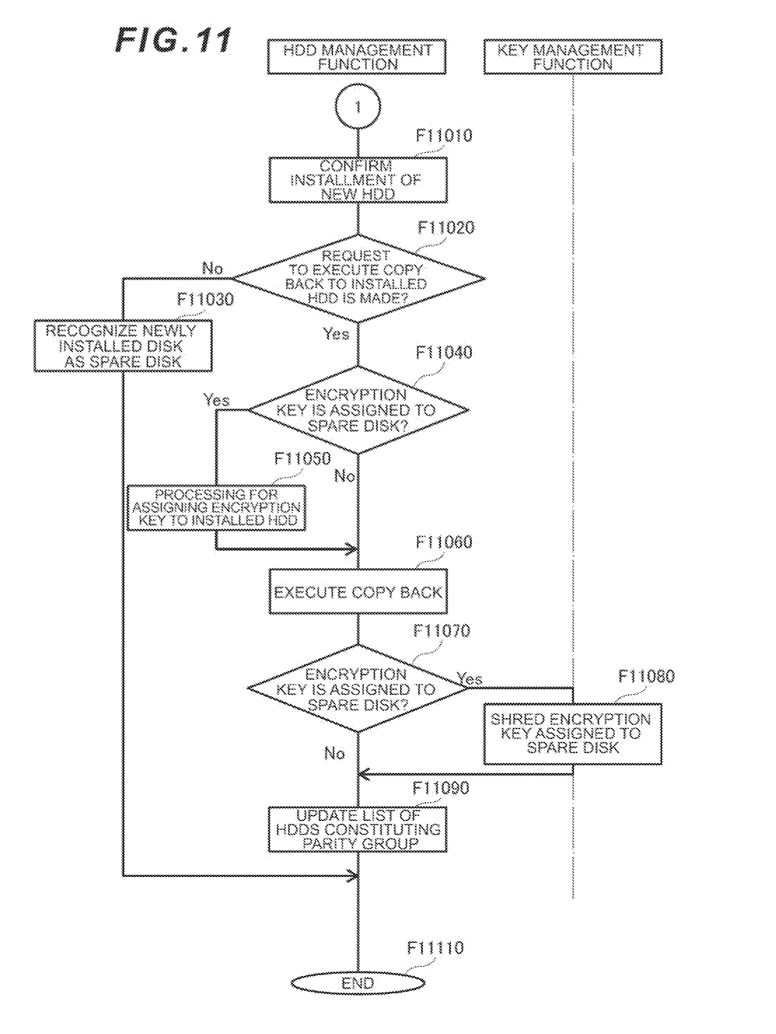

Next, as shown in a flowchart in FIG. 11 which follows the flowchart in FIG. 10, the HDD management function 23220 designates the installation location ID of the removed HDD via the GUI provided by the encryption management function 32100 and requests the user to install a new HDD at this installation location; and if the user inputs that the new HDD has been installed at the designated installation location, the HDD management function 23220 confirms this input (F11010).

Subsequently, the HDD management function 23220 notifies the user of a request to input whether copy-back from the spare disk, in which the data and parity of the removed HDD has been restored, to the new HDD is required or not, via the GUI provided by the encryption management function 32100; and then check if the request to perform the copy-back is made by the user or not (F11020).

If the HDD management function 23220 determines in step F11020 not to perform copy-back from the spare disk to the new HDD (F11020: No), it recognizes the relevant new HDD as a new spare disk (F11030), stores information indicating that the relevant new HDD is a spare disk (“Spare” in FIG. 7), in the intended purpose column 23245 of the HDD management table 23240, recognizes the spare disk, in which the data of the removal target HDD is restored, as a normal HDD, and stores information indicating that the relevant spare disk is a normal HDD (“Normal” in FIG. 7), in the intended purpose column 23245 of the HDD management table 23240.

If it is determined in step F11020 that copy-back from the spare disk, in which the data of the removed HDD is restored, to the new HDD is to be executed (F11020: Yes), the HDD management function 23220 refers to the hot swap management table 23270 and obtains the hot swap destination HDD ID stored in the hot swap destination HDD ID column 23273 corresponding to the ID of the removed HDD (where the letter string “True” is set in FIG. 8).

Then, the HDD management function 23220 refers to the key ID column 23249 of an HDD whose HDD ID in the HDD ID column 23241 of the HDD management table 23240 matches the hot swap destination HDD ID; and judges whether or not an encryption key is assigned to the spare disk (F11040).

If it is determined in step F11040 that an encryption key is assigned to the spare disk (F11040: Yes), that is, if a key ID is stored in the key ID column 23249 of the HDD management table 23240, the HDD management function 23220 executes processing for assigning the encryption key to the new HDD (F11050) and then executes copyback from the spare disk to the new HDD (F11060).

If it is determined in step F11040 that no encryption key is assigned to the spare disk (F11040: No), that is, if no key ID is stored in the key ID column 23249 of the HDD management table 23240, the HDD management function 23220 does not perform step F11050 and executes copy-back from the spare disk to the new HDD (F11060). Incidentally, if encryption is set to a parity group, an encryption key should normally be assigned to a spare disk for the HDD belonging to the relevant parity group.

If the copy-back is normally completed, the HDD management function 23220 judges again whether or not an encryption key is assigned to the relevant spare disk (F11070). If no encryption key is assigned to the relevant spare disk (F11070: No), the HDD management function 23220 updates the HDD ID column 23233 of the parity group management table 23230 to the ID of the new HDD and then stores information indicating that the relevant spare disk is unused (the letter string “Unoperated” in FIG. 7), in the operation status column 23247 of the HDD management table 23240 (F11090). Then, the HDD management function 23220 terminates the flowchart (F11110).

If it is determined in step F11070 that the encryption key is assigned to the relevant spare disk (F11070: Yes), the HDD management function 23220 identifies the key ID of the key assigned to the relevant spare disk from the key ID column 23249 of the HDD management table 23240, designates the key ID to the key management function 23210, and requests for shredding of the relevant encryption key. When the copy-back is completed, the key management function 23210: recognizes that the attribute of the (spare) disk has changed; starts step F11080 for the case where the encryption key is assigned to the (spare) disk; cancels the encryption key with the key ID, for which it has received the shredding request, from the key management table 23250; and then proceeds to step F11090.

If it is necessary to generate an encryption key for the spare disk, the HDD management function 23220 requests the key management function 23210 to generate the spare disk encryption key via the GUI provided by the encryption management function 32100 of the management computer 30000 as will be explained with reference to a flowchart described later.

The removal of an HDD is requested mainly when the HDD is deactivated by a failure and the relevant HDD is to be hot-swapped; however, an HDD is sometimes removed from the storage apparatus in a case of HDD maintenance. Even in a case where the removal of an HDD, in which no failure has occurred, needs to be supported for the purpose of, for example, the HDD maintenance, the processing in steps F10020 and F10022 is executed and then I/O to the HDD is stopped.

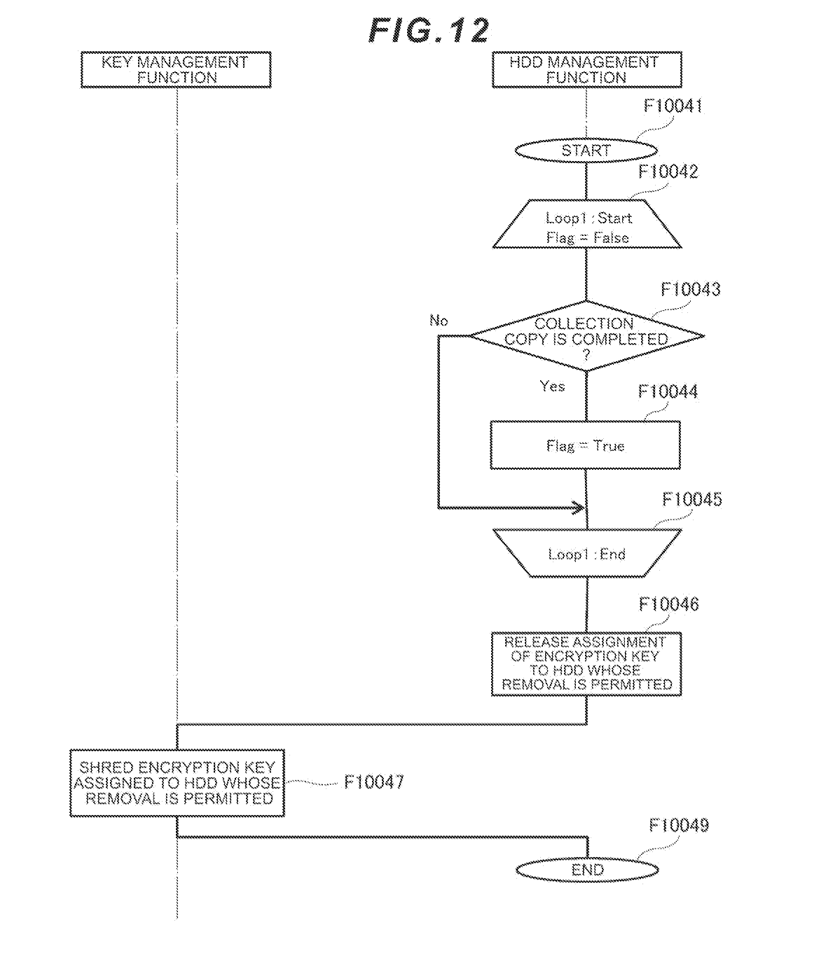

FIG. 12 is a flowchart for controlling timing to execute collection copying to the spare disk and shredding of the encryption key assigned to the removal target HDD. As can be seen from this flowchart, the encryption key of the removal target HDD is retained without being shredded until the collection copying is completed.

If the HDD management function 23220 determines in step F10024 that an encryption key is assigned to the HDD for which the removal permission was granted (F10030), it starts the flowchart in FIG. 12 (F10041). Incidentally, if no encryption key is assigned to the removal target HDD, the HDD management function 23220 does not have to link the timing to shred the encryption key with the progress of collection copying. So, the HDD management function 23220 executes conventional collection copying.

During Loop 1 indicated as steps F10042 through F10045, the HDD management function 23220 waits to proceed to F10046 until the collection copying is completed. Specifically speaking, the HDD management function 23220 sets a collection copy completion flag to False and starts Loop 1 (F10042), refers to the operation status column 23247 of the spare disk in the HDD management table 23240, and confirms the completion of collection copying (F10043). If it is determined in step F10043 that the collection copying is not completed, that is, if the operation status column 23247 of the spare disk in the HDD management table 23240 stores information indicating that the collection copying is being executed (the letter string “In Preparation” in FIG. 7), the HDD management function 23220 proceeds to step F10045 and continues Loop 1.

If it is determined in step F10043 that the collection copying is completed, that is, the operation status column 23247 of the spare disk in the HDD management table 23240 stores information indicating that normal operation is being performed (“Normal” in FIG. 7), the HDD management function 23220 changes the collection copy completion flag to True (F10044). The collection copy completion flag is set to the LM 23200.

After exiting Loop 1 and confirming the implementation (true) of the collection copy completion flag, the HDD management function 23220 cancels the key ID from the key ID column 23249 of the HDD, for which the removal permission was granted, in the HDD management table 23240, releases the assignment of the encryption key to the relevant HDD, and requests the key management function 23210 to cancel the encryption key with the relevant key ID (F10046). The key management function 23210 cancels the key with the key ID from the key management table 23250 (F10047) and then terminates the flowchart (F10049).

It is the most secured way to immediately shred the encryption key and execute crypto-shredding in order to prevent information leakage from the removed HDD. However, when problems such as multiple failures of HDDs occur before the completion of rebuilding (collection copying) of the parity group and it becomes inevitably necessary to restore data from the removed HDD and if the encryption key is shredded, there is a possibility that the data may be read from the removal target HDD, but cannot be decoded, which may lead to data loss. So, after the permission is granted to remove the HDD in which the failure occurred, the encryption key assigned to the relevant HDD is retained until the completion of the collection copying as shown in the flowchart in FIG. 12.

On the other hand, the storage apparatus 20000 can automatically shred the encryption key of the removed HDD regardless of the progress of the collection copying; however, even in this case, the encryption key of the relevant HDD is not shredded for a certain period of time after deciding the removal target HDD or removing the removal target HDD; and then after that, the encryption key is shredded. If a customer engineer (CE) mistakenly removes an HDD, which should not be removed, and immediately shreds the encryption key of that HDD, data stored in the relevant HDD will be lost.

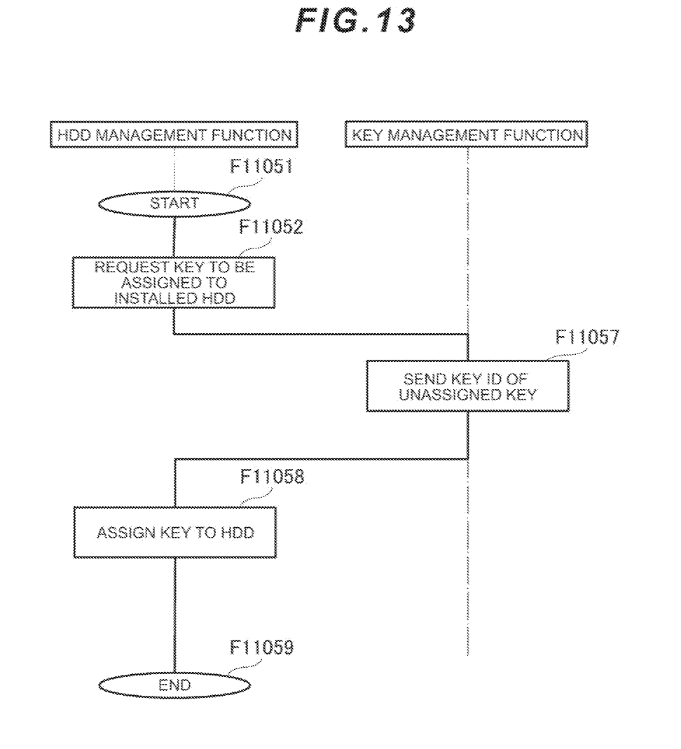

FIG. 13 is a flowchart for explaining the details of processing for assigning an encryption key to an HDD which is newly added to the storage apparatus 20000 in step F11050 (F11050: FIG. 11). If an affirmative judgment is returned in F11020 (FIG. 11) and it is determined that an encryption key is assigned to a spare disk which is a copy-back source for the newly installed HDD, the HDD management function 23220 starts the flowchart (F11051).

The HDD management function 23220 requests the key management function 23210 that the encryption key be assigned to the new HDD (F11052). The key management function 23210 selects the key ID(s) of the encryption key(s), whose status column 23255 in the encryption key management table 23250 stores information indicating the relevant encryption key(s) is not assigned to any HDDs, that is, the relevant encryption key(s) is unused (the letter string “Reserved Key” in FIG. 9), from the key ID column 23251 of the relevant encryption key(s) as many as the number of key IDs requested by the HDD management function 23220 and sends it/them to the HDD management function 23220 (F11057). Incidentally, if there is a shortage of key IDs of encryption keys, the key management function 23210 generates a new encryption key. The HDD management function 23220 stores the key ID, which is received from the key management function 23210, in the key ID column 23249 of the newly installed HDD in the HDD management table 23240 (F11058), and then terminates the flowchart (F11059).

Incidentally, assignment of the encryption key to the new HDD is not limited to the case where the necessity of the copy-back is determined; and the assignment of the encryption key to the new HDD may be immediately executed, for example, when a failed HDD is detected.

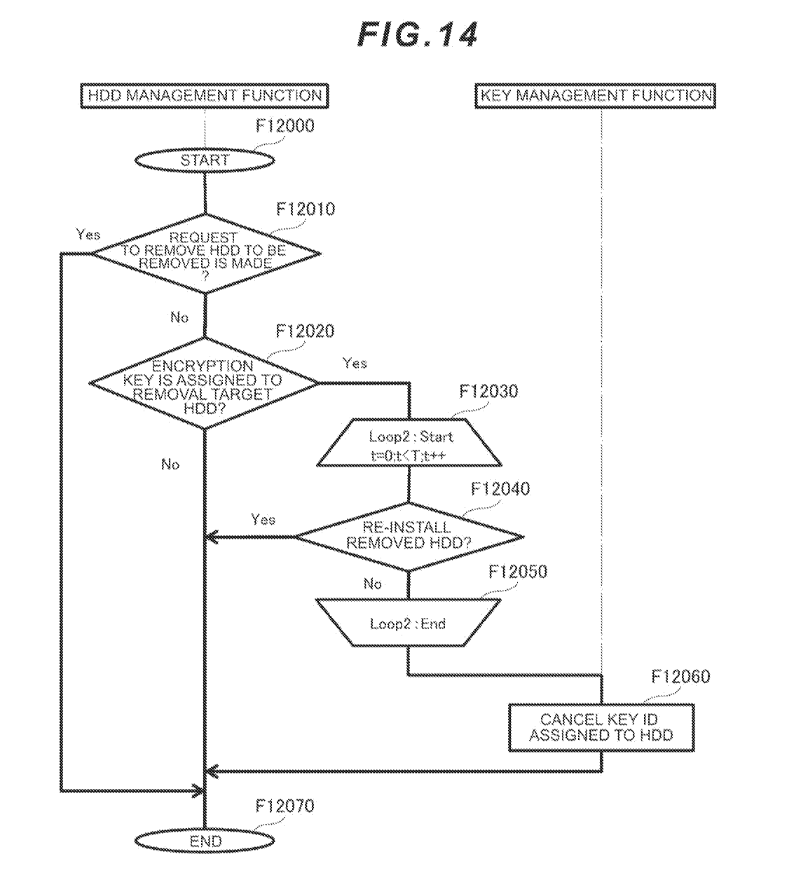

FIG. 14 is a flowchart for explaining processing executed, when removing a certain HDD from the storage apparatus 20000 for the purpose of, for example, maintenance, but not in response to a removal request (request to remove a failed HDD) from the encryption management function, to retain the encryption key assigned to the relevant HDD for a certain period of time and then shred the relevant key if the relevant HDD is not reinstalled within the certain period of time. Incidentally, there may be a dedicated removal request for the removal of a normal HDD for the purpose of, for example, maintenance in order to distinguish it from a removal request to remove a failed HDD.

If the HDD management function 23220 is notified by the storage control function 23270 that an HDD has been removed, or an HDD is to be removed, it starts the flowchart (F12000). The HDD management function 23220 obtains the HDD ID of the removed HDD from the HDD ID column 23241 of the HDD management table 23240 and compares it with the HDD ID of the HDD for which the removal was permitted in step F10024 in FIG. 10 (F12010). If the HDD ID of the relevant HDD is identical to the HDD ID of the HDD whose removal was permitted in step F12010 (F12010: Yes), the HDD management function 23220 terminates the flowchart (F12070).

On the other hand, if the HDD management function 23220 determines in step F12010 that the HDD ID of the relevant HDD is not identical to the ID of the HDD whose removal was permitted (F12010: No), the HDD management function 23220 refers to the key ID column 23249 of the HDD management table 23240 and checks whether or not an encryption key is assigned to the relevant HDD (F12020).

If the HDD management function 23220 determines in step F12020 that no encryption key is assigned to the relevant HDD, that is, no key ID is stored in the key ID column 23249 of the HDD management table 23240 (F12020: No), it terminates the flowchart (F12070).

If the HDD management function 23220 determines in step F12020 that an encryption key is assigned to the relevant HDD (F12020: Yes), that is, a key ID is stored in the key ID column 23249 of the HDD management table 23240, it proceeds to step F12030.

During Loop 2 from step F12030 to step F12050, the HDD management function 23220 judges whether or not the relevant HDD is reinstalled in the storage apparatus 200020 within a certain period of time after the removal of the HDD for the purpose of, for example, maintenance (F12040). If the removed HDD is returned to the storage apparatus 20000 within the certain period of time, the HDD management function 23220 compares the HDD ID of the installed HDD with the HDD ID of the removed HDD. If the HDD ID of the HDD returned to the storage apparatus is identical to the HDD ID of the removed HDD (F12040: Yes), the HDD management function 23220 terminates the flowchart (F12070).

If the HDD ID of the HDD returned to the storage apparatus is not identical to the HDD ID of the removed HDD in step F12040, the HDD management function 23220 terminates Loop 2 after the elapse of the certain period of time after the removal of the HDD. The HDD management function 23220 identifies the key ID of the key assigned to the relevant new HDD from the key ID column 23249 of the HDD management table 23240, designates the key ID to the key management function 23210, and requests for shredding of the encryption key of the removed HDD (F12050).

When the key management function 23210 cancels the encryption key with the key ID, for which the shredding request was made, from the key management table 23250 (F12060) and the HDD management function 23220 confirms the cancellation of the encryption key, the key management function 23210 terminates the flowchart (F12070). When this happens, the HDD management function 23220 reports the shredding of the encryption key assigned to the removed HDD to the user and warns the user about such shredding via, for example, an LED placed on the back face of the storage apparatus 20000. A countdown to the shredding of the encryption key may be reported to the user. A user input means for enabling emergency stop of the shredding of the encryption key may be provided.

If the time width set by Loop 2 is too long, security would be impaired; and if the time width set by Loop 2 is too short, workability of, for example, maintenance would be impaired. Since the long time width and the short time length have a trade-off relationship, an optimum time width is decided in advance as appropriate. The administrator of the storage apparatus 20000 may change the time width.

### Second Embodiment

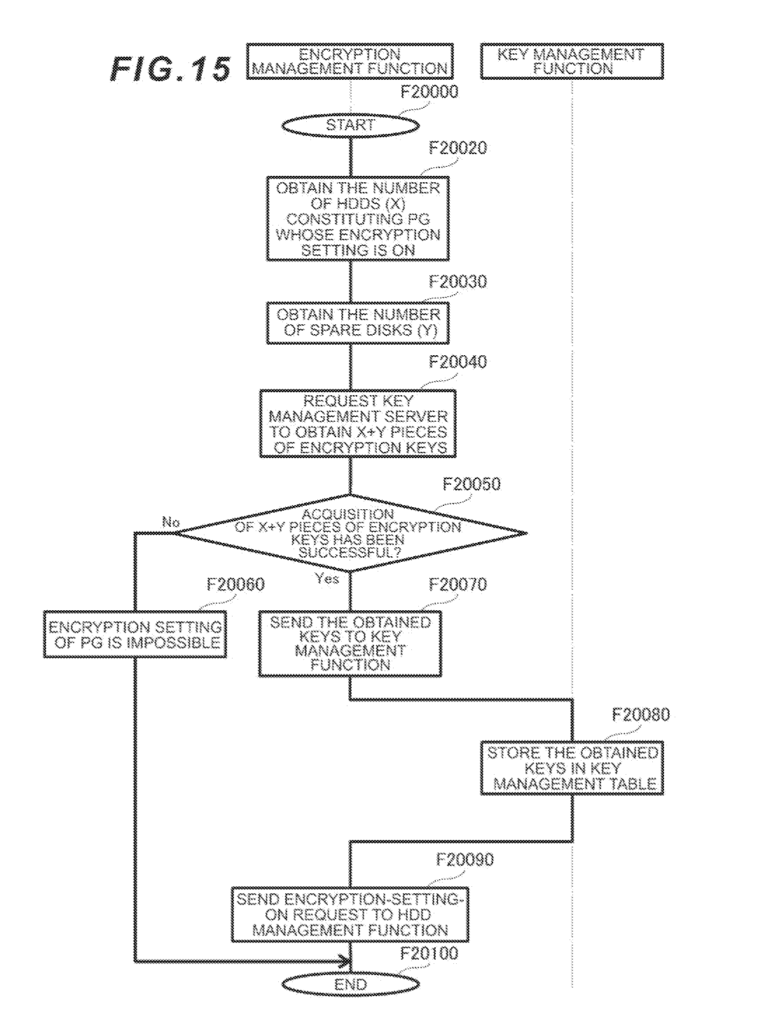

A second embodiment relates to a storage apparatus that imports and uses an encryption key generated by an external key management server for the purpose of encryption/decoding of stored data. Particularly, the second embodiment relates to a computer system designed so that when it is necessary to hot-swap a failed HDD, the storage apparatus 20000 imports an encryption key for a spare disk from the external key management server in advance and the relevant encryption key is prevented from the use for other purposes in preparation for a case of a shortage of encryption keys due to a communication failure with the external key management server, making it impossible to import the encryption keys. The second embodiment will be explained below based on FIG. 15 to FIG. 17.

FIG. 15 is a flowchart for explaining processing executed by the encryption management function 32000 for importing an encryption key to be assigned to a spare disk from the external key management server 80000 in advance in preparation for a case where a failure occurs in HDDs constituting a parity group, at the same time as when the encryption management function 32000 firstly sets the encryption setting of the parity group to on. Incidentally, an encryption key may be prepared in advance for an HDD to be newly added to the storage apparatus.

After the encryption management function 32100 of the management computer 30000 receives a request from the user via the GUI to set the encryption setting of a parity group to on, it starts the processing of the flowchart (F20000). When the encryption management function 32100 obtains the number of HDD IDs (represented as x) stored in the HDD ID column 23233 of the parity group, for which the encryption setting request was made, in the parity group management table 23230 from the key management function 23210 (F20020) and obtains the number of HDDs (represented as y), regarding which the information indicating a spare disk (the letter string “Spare” in FIG. 7) is stored in the intended purpose column 23245 of the HDD management table 23240, from the HDD management function 23220 (F20030), the encryption management function 32100 sends a request to generate and obtain x+y pieces of encryption keys to the key management server 80000 (F20040).

If the encryption management function 32100 determines that it has failed to obtain the x+y pieces of encryption keys from the key management server (F20050: No), it notifies the user via GUI that the encryption setting of the relevant parity group cannot be set to on (F20060); and then terminates the flowchart (F20100).

If the encryption management function 32100 determines in step F20050 that it has successfully obtained the x+y pieces of encryption keys, it sends the relevant encryption keys to the key management function 23210 (F20070); the key management function 23210 stores the received encryption keys in the encryption key management table 23250 and stores information indicating that the relevant encryption key has not been assigned to any HDD yet (the letter string “Reserved Key” in FIG. 9), in the status column 23255 (F20080). Next, the encryption management function 32100 sends a encryption-setting-on request for a parity group by means of input by the user to the HDD management function 23220 (F20090) and then terminates the flowchart (F20100).

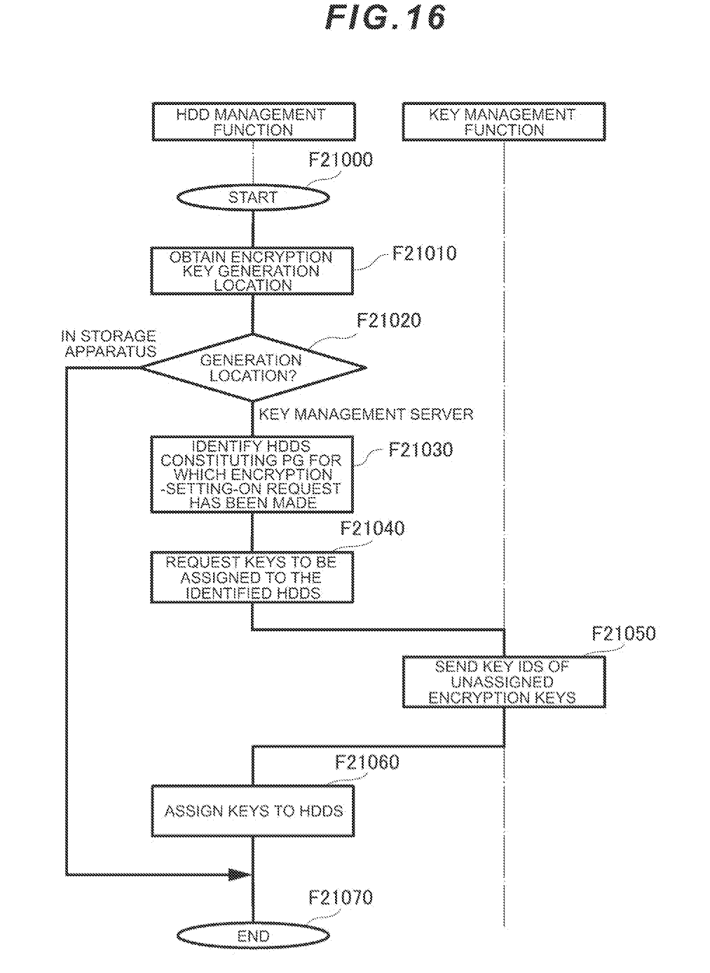

FIG. 16 is a flowchart for explaining processing for assigning an encryption key to HDDs constituting the parity group for which the encryption-setting-on request was made by the user. After receiving the encryption-setting-on request for the parity group input by the user from the encryption management function 32100, the HDD management function 23220 starts the flowchart (F21000).

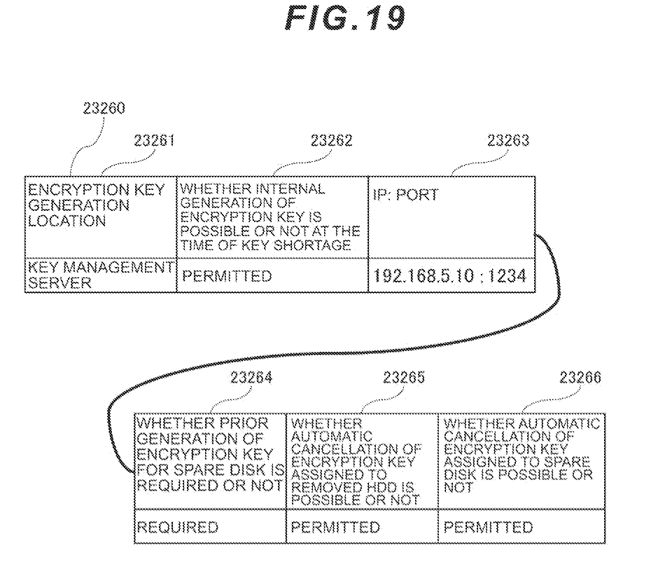

The HDD management function 23220 obtains the encryption key generation location (see the encryption key generation policy table 23260 in FIG. 19) from the key management function 23210 (F21010). When this happens, the key management function 23210 refers to the encryption key generation location column 23261 of the encryption key generation policy table and returns the information indicating the encryption key generation location to the encryption management function 32100.

If the HDD management function 23220 determines that the encryption key generation location is inside the storage apparatus (F21020: Inside Storage Apparatus), it proceeds downstream from step F21060. If the HDD management function 23220 determines that the encryption key generation location is the key management server (F21020: Key Management Server), it identifies HDDs constituting the parity group, for which the encryption-setting-on request was made by means of input by the user, from the HDD ID column 23233 of the parity group management table 23230 (F21030) and requests as many encryption keys as the number of the HDDs constituting the parity group from the key management function 23210 (F21040).

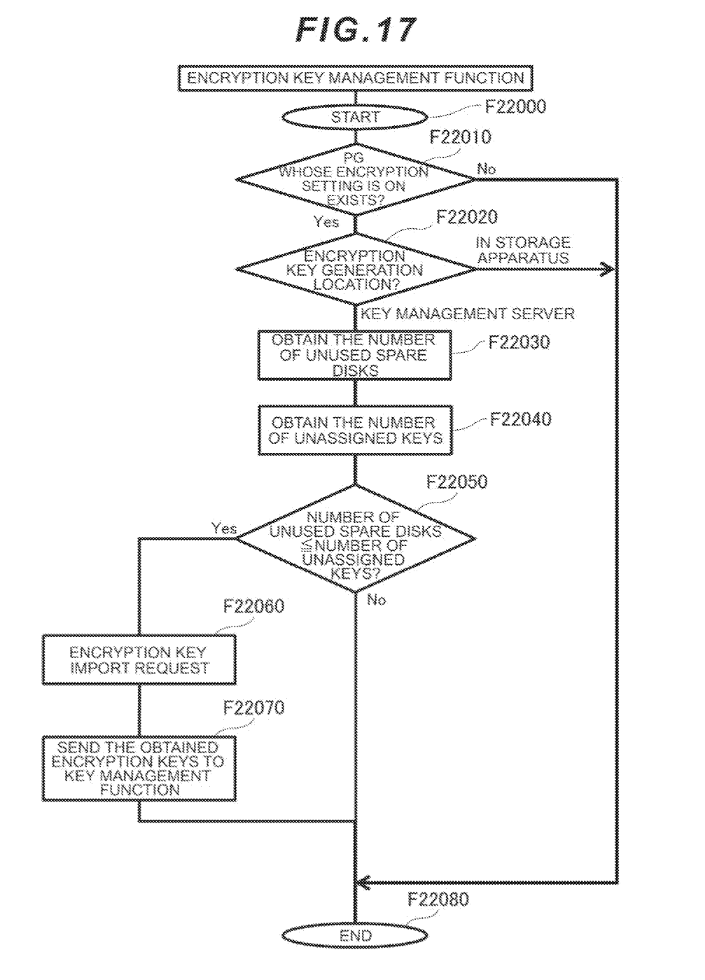

Incidentally, if the encryption key generation location is inside the storage apparatus, the key management function 23210 does not access the external key management server 80000, which is the only difference from the above-described flow; and the execution of steps from F21030 to F21060 by the HDD management function 23220 is the same as the flow in the case where the encryption key generation location is the key management server 80000. The same applies to a flowchart in FIG. 17 described later.

The key management function 23210 identifies as many key IDs of keys, regarding which the information indicating that the relevant key has not been assigned to any HDD (the letter string “Reserved Key” in FIG. 9) is stored in the status column 23255 of the key management table 23250, as the number of keys requested by the HDD management function 23220 based on the key ID column 23251 and sends them to the HDD management function 23220 (F21050).

The HDD management function 23220 assigns the key IDs received from the key management function 23210 to the HDDs constituting the parity group for which the encryption-setting-on request was made, that is, the HDD management function 23220 stores the key IDs in the key ID column 23249 (the HDD management table 23240) of the relevant HDDs (F21060) and then terminates the flowchart (F21070).

FIG. 17 is a flowchart for explaining processing executed by the encryption management function 32100 for requesting the external key management server to import an encryption key when the user logs into the encryption management function 32100 during the operation by the storage apparatus 20000 recognizing the encryption key generation location to be the key management server and if a parity group whose encryption setting is on exists in the relevant storage apparatus and the number of encryption keys in an unassigned state is less than the number of spare disks in an unused state.

The encryption management function 32100 starts the flowchart based on a login by the user (F22000). The encryption management function 32100 obtains information indicating whether the parity group whose encryption setting is on exists or not, from the HDD management function 23220 of the storage apparatus 20000 (F22010). When this happens, the HDD management function 23220 refers to the encryption setting column 23237 of the parity group management table 23230 and check whether the information indicating that the encryption setting is on (the letter string “ON” in FIG. 6) exists or not.

If it is determined in step F22010 that no parity group whose encryption setting is on exist, the encryption management function 32100 terminates the flowchart (F22080). If it is determined in step F22010 that the parity group whose encryption setting is on exists, the key management function 23210 obtains the encryption key generation location (F22020). When doing so, the key management function 23210 refers to the encryption key generation location column 23261 of the key generation policy table 23260 and returns the information indicating the encryption key generation location to the encryption management function 32100.

If the encryption key generation location is inside the storage apparatus in step F22020, the encryption management function 32100 terminates the flowchart (F22080). If the encryption key generation location is the key management server in step F22020, the encryption management function 32100 obtains the number of unused spare disks from the HDD management function 23220 (F22030). When this happens, the HDD management function 23220 calculates the number of HDDs, regarding which the information indicating that the relevant HDD is a spare disk (the letter string “Spare” in FIG. 7) is stored in the intended purpose column 23245 of the HDD management table 23240 and the information indicating that the relevant HDD is unused (the letter string “Unoperated” in FIG. 7) is stored in the operation status column 23247; and sends the calculated number of HDDs to the encryption management function 32100.

Next, the encryption management function 32100 obtains the number of unassigned keys from the key management function 23210 (F22040). When this happens, the key management function 23210 calculates the number of keys, regarding which the information indicating that the relevant key has not been assigned to any HDD yet (the letter string “Reserved Key” in FIG. 9) is stored in the status column 23255 of the key management table 23250; and sends the calculated number of keys to the encryption management function 32100.

The encryption management function 32100 compares the number of unused spare disks obtained from the HDD management function 23220 with the number of unassigned keys obtained from the key management function 23210 (F22050). If the number of unused spare disks is less than the number of unassigned keys in step F22050, the encryption management function 32100 terminates the flowchart (F22080).

If the number of unused spare disks is more than the number of unassigned keys in step F22050, the encryption management function 32100 requests the key management server 80000 via the GUI to import as many encryption keys as the number obtained by subtracting the number of unassigned keys from the number of unused spare disks (F22060). When the user executes the encryption key import and sends the imported encryption keys to the key management function 23210 (F22070) and the key management function 23210 stores the relevant encryption keys in the key management table 23250, the encryption management function 32100 terminates the flowchart (F22080).

### Third Embodiment

In a third embodiment, the user sets the encryption key generation location, whether prior generation of an encryption key for a spare disk is required or not, and whether automatic cancellation of an encryption key is possible or not, which are set as encryption key management policies and are to be used for encryption/decoding of stored data; and as a result, the encryption key management function 23210 generates and/or cancels the relevant key in accordance with the relevant policy.

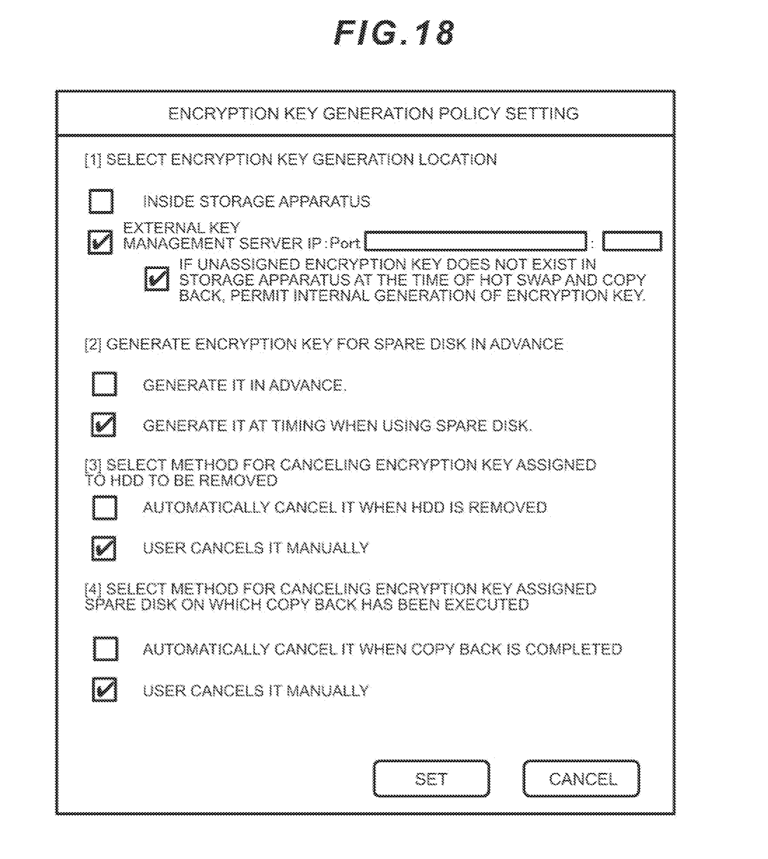

FIG. 18 is an example of an encryption key generation policy setting GUI provided by the encryption management function 32100. The user selects the encryption key generation location from either inside the storage apparatus or the external key management server; and if the user selects the external key management server, the user sets whether internal generation of an encryption key is permitted or not if an unassigned encryption key does not exist in the storage apparatus at the time of an event which urgently requires an encryption key, for example, at the time of hot swap and copy-back. If the external key management server is selected as the encryption key generation location, the user sets an IP address of the relevant external key management server and sets whether or not an encryption key for a spare disk should be generated in advance or not. The user selects a method for cancelling the encryption key assigned to the removed HDD and the encryption key assigned to the spare disk on which the copy-back has been executed, from automatic cancellation or manual cancellation by the user.

FIG. 19 is a configuration example for the encryption key management policy table 23260 to which the key management function 23210 refers. The encryption key management policy table 23260 is constituted from: an encryption key generation location column 23261 for storing information indicating the encryption key generation location; a “whether internal generation of encryption key is possible or not at the time of key shortage” column 23262 for storing information indicating whether the internal generation is possible or not when an encryption key that is not assigned to any HDD inside the storage apparatus does not exist at the time of hot swap and copy-back; an “IP: Port” column 23263 indicating connection information of the relevant key management server when the encryption key generation location is the key management server; a “whether prior generation of encryption key for spare disk is required or not” column 23264 for storing information indicating whether prior generation of an encryption key for a spare disk is required or not; a “whether automatic cancellation of encryption key assigned to removed HDD is possible or not” column 23265 for storing information indicating whether automatic cancellation of the encryption key assigned to the removed HDD is possible or not; and a “whether automatic cancellation of encryption key assigned to spare disk is possible or not” column 23266 for storing information indicating whether automatic cancellation of the encryption key assigned to the spare disk on which the copy-back has been executed is possible or not.

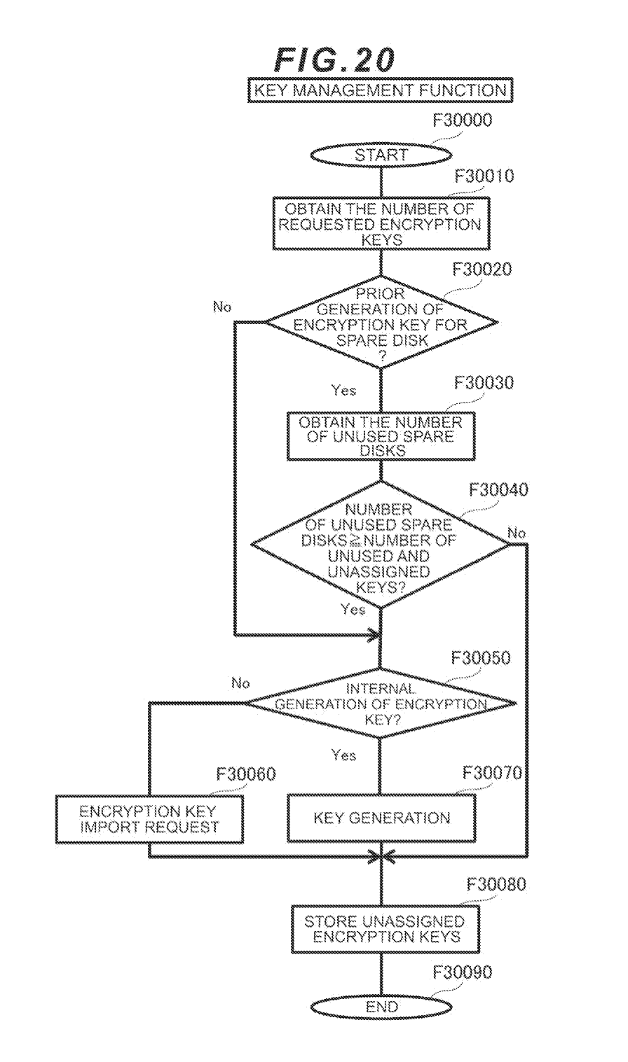

FIG. 20 is a flowchart for explaining processing executed by the key management function 23210 for generating an encryption key when the HDD management function 23220 issues an encryption key setting request in accordance with the encryption key management policy designated by the user. After receiving an encryption key generation request, including information of an encryption key assignment target HDD, from the HDD management function 23220, the key management function 23210 starts the processing of the flowchart (F30000). The information of the encryption key assignment target HDD herein used is information to, for example, judge whether the target HDD to which the encryption key should be assigned is an HDD constituting a parity group, for which an encryption-setting-on request was made by the user, or a spare disk on which hot swap is to be executed because a failure occurred in an HDD constituting a parity group whose encryption setting is on, or an HDD newly installed in the storage apparatus 2000 by means of replacement of an HDD in which a failure occurred.

The key management function 23210 analyzes a request for the encryption key and obtains the requested number of encryption keys (F30010). Next, the key management function 23210 refers to the “whether prior generation of encryption key for spare disk is required or not” column 23264 in the key generation policy table 23260 and judges whether prior generation of encryption keys for spare disks is required or not (F30020).

If it is found in step F30020 that the “whether prior generation of encryption key for spare disk is required or not” column 23264 of the key generation policy table 23260 stores information indicating that the prior generation of the spare disk encryption key is not required (the letter string “Not Required” in FIG. 19) (F30020: No), the key management function 23210 proceeds to step F30050 in order to generate the number of the encryption keys found in step F30010.

If it is found in step F30020 that the “whether prior generation of encryption key for spare disk is required or not” column 23264 of the key generation policy table 23260 stores information indicating that the prior generation of the spare disk encryption key is required (the letter string “Required” in FIG. 19), the key management function 23210 obtains the number of unused spare disks from the HDD management function 23220 (F30030).

When this happens, the HDD management function 23220 calculates the number of HDDs (the number of unused spare disks), regarding which the information indicating that the relevant HDD is a spare disk (the letter string “Spare” in FIG. 7) is stored in the intended purpose column 23245 of the HDD management table 23240 and the information indicating that the relevant HDD is unused (the letter string “Unoperated” in FIG. 7) is stored in the operation status column 23247; and sends the calculated number of HDDs to the key management function 23210.

The key management function 23210 compares the number of encryption keys (the number of unused and unassigned encryption keys) obtained by subtracting the number of encryption keys requested by the HDD management function 23220 from the number of encryption keys, regarding which the information indicating that the relevant key has not been assigned to any HDD yet (the letter string “Reserved Key” in FIG. 9) is stored in the status column 23255 of the key management table 23250, with the number of unused spare disks received from the HDD management function 23220 (F30040).

If it is found in step F30040 that the number of unused spare disks is less than the number of unused and unassigned keys (F30040: No), the key management function 23210 proceeds to step F30080. If it is found in step F30040 that the number of unused spare disks is more than the number of unused and unassigned keys (F30040: Yes), the key management function 23210 refers to the encryption key generation location column 23261 and the “whether internal generation of encryption key is possible or not at the time of key shortage” column 23262 of the key generation policy table 23260 and identifies the encryption key generation location (F30050) in order to generate as many encryption keys as the number calculated by subtracting the number of unused and unassigned keys from the number of unused spare disks.

If it is found in step F30050 that the encryption key generation location is the encryption key management server 80000 and the internal generation is not possible at the time of a key shortage, or the encryption key generation location is the encryption key management server 80000 and the HDD to which the relevant encryption key is to be assigned is an HDD constituting a parity group for which an encryption-setting-on request was made by the user (F30050: No), the key management function 23210 issues an encryption key import request to the encryption key management server 80000 via the GUI provided by the encryption management function 32100 of the management computer 30000 (F30060) and proceeds to step F30080.

If it is found in step F30050 that the encryption key generation location is inside the storage apparatus or the HDD to which the encryption key is to be assigned is a spare disk for executing hot swap because a failure has occurred in an HDD constituting the parity group, whose encryption setting is on, or is an HDD newly installed because of replacement of the HDD in which the failure occurred, and the encryption key generation location is the key management server and the internal generation is possible at the time of a key shortage (F30050: Yes), the encryption key management function 23210 generates an encryption key inside the storage apparatus 20000, stores the relevant encryption key in the key column 23253 of the key management table 23250, stores the information indicating that the relevant key has not been assigned to any HDD yet (the letter string “Reserved Key” in FIG. 9), in the status column 23255 of the relevant key (F30080) and terminates the processing (F30090).

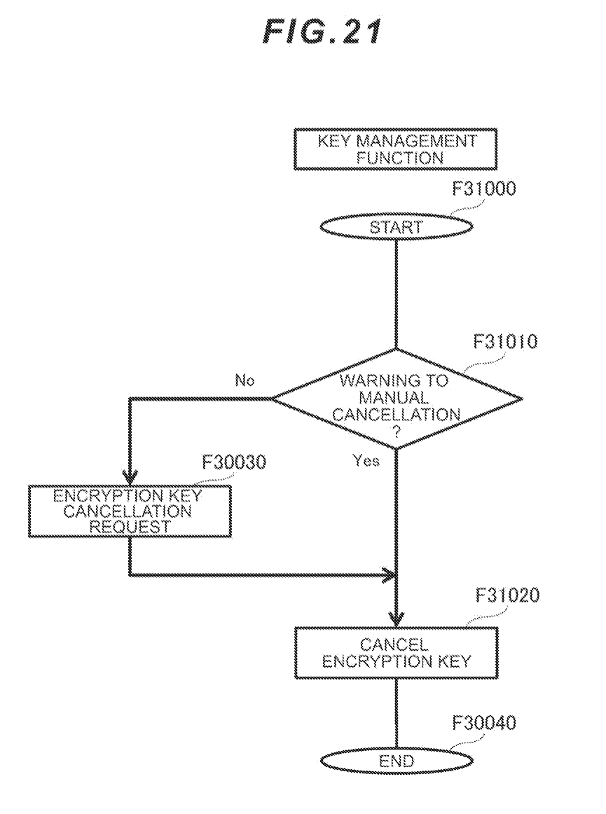

FIG. 21 is a flowchart for explaining processing executed by the key management function 23210 for cancelling an encryption key in accordance with the encryption key management policy designated by the user when an encryption key cancellation request is issued by the HDD management function 23220.

After receiving the encryption key cancellation request, including the key ID and information indicating whether the HDD to which the relevant key is assigned is the removed HDD or a used spare disk, from the HDD management function 23220, the key management function 23210 starts the flowchart (F31000).

The key management function 23210 refers to the “whether automatic cancellation of encryption key assigned to removed HDD is possible or not” column 23265 of the encryption key generation policy table 23260 if the HDD to which the relevant encryption key is assigned is the removed HDD; or the key management function 23210 refers to the “whether automatic cancellation of encryption key assigned to spare disk is possible or not” column 23266 of the encryption key generation policy table 23260 if the HDD to which the relevant encryption key is assigned is the used spare disk; and then the key management function 23210 judges whether automatic cancellation of the relevant encryption key is possible or not (F31010).

If it is determined in step F31010 that the encryption key can be automatically canceled, that is, the information indicating that the encryption key may be automatically canceled (the letter string “Permitted” in FIG. 21), is stored in the “whether automatic cancellation of encryption key assigned to removed HDD is possible or not” column 23265 and/or the “whether automatic cancellation of encryption key assigned to spare disk is possible or not” column 23266 of the encryption key generation policy table 23260 (F31010: Yes), the key management function 23210 cancels the relevant encryption key from the key management table 23240 (F31020).

If it is determined in step F31010 that the encryption key cannot be automatically canceled, that is, the information indicating that the encryption key may not be automatically canceled (the letter string “Not Permitted” in FIG. 21), is stored in the “whether automatic cancellation of encryption key assigned to removed HDD is possible or not” column 23265 and/or the “whether automatic cancellation of encryption key assigned to spare disk is possible or not” column 23266 of the encryption key generation policy table 23260, the key management function 23210 notifies the user of the request to cancel the relevant encryption key via the GUI provided by the encryption management function 32100 of the management computer 30000 (F31030). When the user issues instruction to cancel the relevant encryption key, the key management function 23210 cancels the relevant encryption key from the key management table 23240 (F31020). When the key management function 23210 cancels the encryption key, it terminates the flowchart. Incidentally, a case where automatic cancellation of the encryption key is not desired is a case where a user who wants manual management of the life cycle of keys may exist or a case where the removed HDD is to be reinstalled and used.

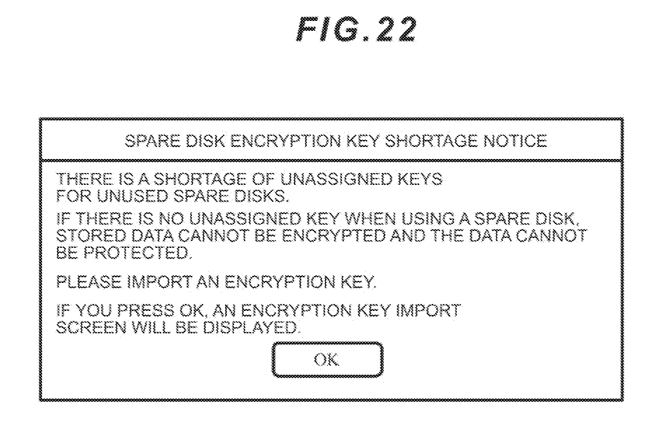

FIG. 22 is the form of an example of a warning reported by, for example, e-mail to a management terminal of an administrative user from the key management function 23210. If the key management function 23210 executes collection copying and thereby determines based on the processing of the flowchart described earlier that there is a shortage of unassigned keys for unused spare disks, it notifies the administrative user of this warning and urges them to import the encryption keys from the key management server, thereby protecting confidentiality of data and avoiding data loss.

According to the aforementioned embodiments, when removing an HDD, in which a failure has occurred, after the execution of hot swap in the storage apparatus having a stored data encryption function, an encryption key assigned to that HDD is shredded and thereby data in the HDD is automatically crypto-shredded; and after a new HDD is installed, data in a spare disk regarding which copy-back to the new HDD is completed is automatically crypto-shredded and key generation for the spare disk is requested to a security administrator in preparation for the next hot swap. Then, with the storage apparatus which imports and uses an encryption key generated by the external key management server for encryption/decoding of stored data, the encryption key for the spare disk is imported from the external key management server in advance and the encryption key is prevented from the use other than the intended use in preparation for a case where the encryption key may not be imported due to a communication failure with the external key management server at the time of the hot swap, thereby causing a shortage of encryption keys.

In the aforementioned embodiments, the controller for the storage apparatus assigns an encryption key to an HDD; however, if the HDD is an HDD equipped with a self-encryption function, the aforementioned embodiments can be applied to the HDD equipped with the self-encryption function by replacing the encryption key with an authentication key.

### REFERENCE SIGNS LIST

10000 Computer system
20000 Storage apparatus
30000 Management computer
40000 Host computer
80000 Key management server

1. A computer system comprising:
a plurality of storage media;
a first circuit constituting an interface with a host computer;
a second circuit constituting an interface with the plurality of storage media; and
a controller;
wherein the controller:
assigns key information to each of the plurality of storage media;
divides data from the host computer into a plurality of divided data and generates parity based on the plurality of divided data;
encrypts, distributes, and stores the parity and the plurality of divided data in the plurality of storage media;
determines a specific storage medium from among the plurality of storage media;
stores the parity or the divided data, which are stored in the specific storage medium, in a spare storage medium; and
controls timing to cancel the key information assigned to the specific storage medium based on timing to finish storing the parity or the divided data in the spare storage medium and cancels the key information in accordance with the controlled timing.

2. The computer system according to claim 1, wherein when removing the specific storage medium from a storage area of the plurality of storage media, the controller cancels the key information assigned to the specific storage medium.

3. The computer system according to claim 2, wherein the controller:
assigns the key information to the spare storage medium;
assigns the key information to another storage medium other than the plurality of storage media and migrates the parity or the divided data, which are restored in the spare storage medium, to the other storage medium to which the key information is assigned; and
cancels the key information assigned to the spare storage medium when the migration of the parity or the divided data is completed.

4. The computer system according to claim 2, wherein the controller forms the key information to be assigned to the spare storage medium before the divided data or the parity in the specific storage medium is restored to the spare storage medium.

5. The computer system according to claim 4, wherein the controller forms the key information by importing it from a key management server in advance.

6. The computer system according to claim 1, wherein the controller judges whether or not a request is made to migrate the parity or the divided data, which are restored in the spare storage medium, to another storage medium; and
if an affirmative judgment result is obtained in this judgment, the controller judges whether or not an encryption key is assigned to the spare storage medium; and
if an affirmative judgment result is obtained in this judgment, the controller assigns the key information to another storage medium other than the plurality of storage media and migrates the parity and/or the divided data, which are restored in the spare storage medium, to the other storage medium to which the key information is assigned; and
if the migration of the parity or the divided data is completed, the controller cancels the key information assigned to the spare storage medium.

7. The computer system according to claim 2, wherein the controller retains an encryption key assigned to the specific storage medium without cancelling it until the restoration of the divided data or the parity in the specific storage medium to the spare storage medium is completed.

8. The computer system according to claim 2, wherein the controller judges whether or not a removal request is made for a storage medium to be removed from the storage area;
if a negative judgment result is obtained in this judgment, the controller judges whether or not the key information is assigned to the storage medium;
if an affirmative judgment result is obtained in this judgment, the controller judges whether or not the storage medium, which is removed from the storage area at specified time, is to be reinstalled in the storage area; and
if an affirmative judgment result is obtained in this judgment, the controller maintains the key information assigned to the storage medium; and if a negative judgment result is obtained in the above judgment, the controller cancels the key information of the storage medium removed from the storage area after the specified time.

9. The computer system according to claim 8, wherein when cancelling the key information of the storage medium, the controller reports the cancellation of the key information to an administrator before the cancellation.

10. The computer system according to claim 5, wherein when setting encryption to the parity group, the controller:
obtains the key information, which is to be assigned to the spare storage medium, from the key management server; and
assigns the obtained key information to the spare storage medium.

11. The computer system according to claim 10, wherein the controller:
obtains the number of the storage media constituting the parity group for which an encryption setting was requested by the administrator;
obtains the number of spare storage media for the parity group for which the encryption setting was requested;
requests the key management server to provide the key information as many as a total number of the number of the storage media constituting the parity group and the number of the spare storage media; and
assigns the key information obtained from the key management server to the storage media constituting the parity group and to the spare storage media.

12. The computer system according to claim 5, having one or more spare storage media in which the divided data or the parity of the specific storage medium is not restored,
wherein the controller:
has the key information which is not assigned to the storage media;
compares the number of pieces of the key information with the number of the spare storage media in which the divided data or the parity of the specific storage medium is not restored; and
requests the key information from the key management server if the number of the spare storage media is equal to or less than the number of pieces of the key information.

13. The computer system according to claim 1, wherein the controller sets a policy for managing the key information and assigns the key information to the plurality of storage media and the spare storage medium in accordance with the set policy.

14. The computer system according to claim 13, wherein if management information indicating whether the key information is generated by the controller and/or obtained from the key management server, and the key information to be assigned to the spare storage medium do not exist in the controller, the controller has the policy include management information indicating whether generation of the key information by the controller is permitted or not.

15. The computer system according to claim 13, wherein the controller has the policy include whether the key information to be assigned to the spare storage medium should be formed or not before the divided data or the parity of the specific storage medium is reproduced in the spare storage medium.

16. The computer system according to claim 15, wherein the controller has the policy include that the key information to be assigned to the spare storage medium is to be formed; and if the key information is not formed in the controller, the controller obtains the key information from a key management server.

17. The computer system according to claim 13, wherein the controller has the policy include information about cancellation of the key information assigned to the specific storage medium and/or the spare storage medium.

18. The computer system according to claim 17, wherein the controller has the policy include whether automatic cancellation of the key information assigned to the specific storage medium and/or the spare storage medium is possible or not; and
If the automatic cancellation of the key information is not possible, the controller reports to an administrator that the key information needs to be canceled manually.

19. A computer system comprising:
a first circuit constituting an interface with a host computer;
a second circuit constituting an interface with a plurality of storage media; and
a controller;
wherein the controller:
divides data from a host computer into a plurality of divided data and generates parity based on the plurality of divided data;
assigns key information to each of a plurality of storage media;
encrypts, distributes, and stores the parity and the plurality of divided data in the plurality of storage media;
restores the parity or the divided data, which are stored in a specific storage medium belonging to the plurality of storage media, to a spare storage medium;
determines the specific storage medium from among the plurality of storage media;
assigns key information to the spare storage medium;
encrypts and stores the parity or the divided data, which are stored in the specific storage medium, in the spare storage medium;
cancels the key information assigned to the specific storage medium when removing the specific storage medium from a storage area of the plurality of storage media;
migrates the parity and/or the divided data, which are restored in the spare storage medium, to another storage medium to which the key information is assigned; and
cancels the key information assigned to the spare storage medium if the migration of the parity or the divided data is completed.

20. A method for controlling a computer system,
wherein the computer system:
divides data from a host computer into a plurality of divided data and generates parity based on the plurality of divided data;
assigns key information to each of a plurality of storage media;
encrypts, distributes, and stores the parity and the plurality of divided data in the plurality of storage media; and
when restoring the parity or the divided data, which are stored in a specific storage medium belonging to the plurality of storage media, to a spare storage medium, determines the specific storage medium from among the plurality of storage media, stores the parity or the divided data, which are stored in the specific storage medium, in the spare storage medium based on the plurality of storage media other than the specific storage medium, controls timing to cancel the key information assigned to the specific storage medium based on timing to finish storing the parity or the divided data in the spare storage medium, and cancels the key information in accordance with the controlled timing.
